(19) United States
(12) Patent Application Publication
(10) Pub. No.: US 2003/0088642 A1
(43) Pub. Date: May 8, 2003

(54) Device operator panel operated as a web browser

(75) Inventors: Stephen G. Price, Longmont, CO (US); Larry D. Teklits, Loveland, CO (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/003,013

(22) Filed: Nov. 2, 2001

(51) Int. Cl. G06F 15/16

(52) U.S. Cl. 709/218

(57) ABSTRACT

A computer controlled device, such as a networked printer, that incorporates a HyperText Transfer Protocol (HTTP) browser as the operator control device. The computer controlled device already incorporates an HTTP server to allow remote control of the device from other computers or devices on the network. The incorporation of an HTTP browser allows reuse of the HTTP server software as the front panel controls driver, obviating the requirement for the development and maintenance of an independent software module to drive the front panel controls.

### BACKGROUND OF THE INVENTION

1. Field of the Invention

This invention generally relates to the field of status and message displays that are built into electronic equipment, and more particularly relates to the generation of information for operator displays and the processing of operator input used to control computer controlled equipment.

2. Description of Related Art

Electronic equipment, including any equipment which is controlled by electronic circuits, usually incorporate a display on the equipment to display messages and facilitate an operator's control of the equipment. Examples of such equipment include medium to large computer printers, programmable thermostats and radio equipment. The displays range from large graphical displays with a keyboard and mouse input to a display capable of showing one or a few lines of text along with a few indicator lights. Equipment with simpler displays may utilize one or a few buttons and/or dials to allow an operator to input information into the equipment. Electronically controlled equipment that incorporate operator interface hardware on the equipment itself must incorporate processing to control the display and monitor operator inputs

Many types of electronically controlled equipment may also be controlled remotely through information communicated over an electronic communications link. The communications used to remotely control equipment may be in the form of a multiplicity of control lines which each control a particular element of the equipment. Equipment may also accept commands received through a single communications link. A single communications link used to control a piece of equipment may take many forms, such as a wired serial communications link or a radio communications link. The equipment may also transmit status or other information over the same or different communications means to remote locations.

Electronically controlled equipment may further be connected to a data communications network where other devices that are connected to the network may monitor the status of the device and issue commands to be executed by the piece of equipment. These devices may also receive status or other information transmitted by the controlled equipment.

The connection of equipment to communications networks has greatly increased the flexibility in the use of electronic equipment. Operators may now control equipment from any communications terminal or suitably configured piece of equipment that is connected to the communications network.

The development of the HyperText Transfer Protocol (HTTP) has facilitated the flexible and adaptable communications of information over a data network. HTTP allows the transmission of a standardized set of commands to produce a graphical display at a remote location. A device transmitting an HTTP data sequence can cause a graphical display to be produced at a remote location, usually on a computer or other graphical display. The graphical display produced by an HTTP transmission may incorporate display elements which allow the viewer to enter data or to make selections that are returned to the transmitting device. The selections which are returned to the transmitting device may cause an action to occur in the device, such as to control an element in the device, or the selection may cause additional data to be transmitted by the device. The additional data may produce a different display at the remote location.

Electronically controlled equipment which interface with remote devices incorporate specialized processing to perform the external communications and processing of the commands and data input and output to the remote device. The software and/or circuits to perform this processing are mostly duplicitous with the processing that supports the operator interface that is a part of the electronically controlled equipment. Modification of the operator interface for such electronically controlled equipment requires modification of both of these processing components.

Therefore a need exists to overcome the problems with the prior art as discussed above, and particularly for a device architecture which allows more streamlined modification of operator interface functions.

### SUMMARY OF THE INVENTION

According to a preferred embodiment of the present invention, a device operator panel operated as a web browser is a method of presenting an operator interface for a controller which comprises the steps of (i) generating a operator display dataset within a computer controller, wherein the operator display data defines an operator interface display and wherein the display data conforms to a network protocol, (ii) interpreting the operator display dataset within the computer controller and (iii) displaying the operator interface display.

According to a preferred embodiment of the present invention, a device operator panel operated as a web browser is an apparatus with an operator display dataset generator for generating a display dataset, wherein the display dataset defines an operator interface display and wherein the display data conforms to a network protocol. The apparatus also contains a display dataset interpreter, communicatively coupled to the operator display dataset generator, for interpreting the operator display dataset, wherein the display dataset interpreter is contained within the computer controlled device. The apparatus further contains an operator interface display, electronically coupled to the display dataset interpreter, for displaying the operator interface display.

### BRIEF DESCRIPTION OF THE DRAWINGS

FIG. 1 is a block diagram illustrating the processing architecture of a networked printer in accordance with a preferred embodiment of the present invention.

FIG. 2 is a software component structural diagram for the system of FIG. 1, according to a preferred embodiment of the present invention.

FIG. 3 is an operation flow diagram for a web server incorporated into the system of FIG. 1, according to preferred embodiments of the present invention.

FIG. 4 is an operation flow diagram for a web browser incorporated into the system of FIG. 1, according to preferred embodiments of the present invention.

FIG. 5 illustrates an operator display presented to an operator on a display that is part of an illustrated embodiment of the present invention.

### DESCRIPTION OF THE PREFERRED EMBODIMENTS

The present invention, according to a preferred embodiment, overcomes problems with the prior art by providing an HTTP Browser within a computer controlled, communications network attached printer. The incorporation of an HTTP Browser within this printer allows the HTTP server software within the printer to be reused to drive the printer's operator panel display and obviates the need for independent software modules to generate the operator panel display and process operator inputs.

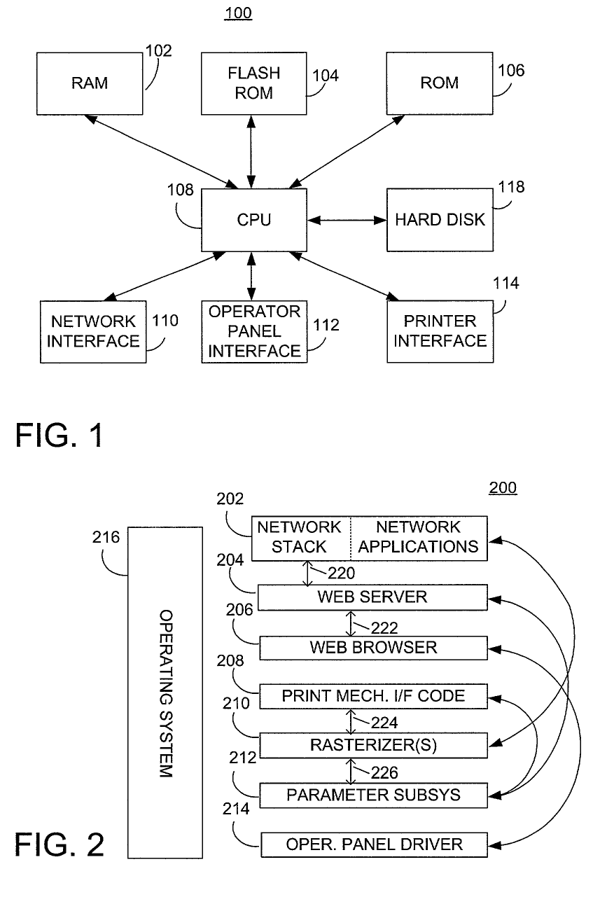

The present invention will be described through a preferred embodiment that is a computer printer which contains an internal microprocessor that accepts print data as well as printer control inputs over a network connection. The processing configuration 100 of this preferred embodiment is illustrated in FIG. 1. The example embodiment comprises a Central Processing Unit (CPU) 108 which is a programmable microprocessor. The CPU 108 utilizes non-volatile memory in ROM 106 and/or FLASH ROM 104 to store program commands and other information which does not change. Relevant to the embodiment of the present invention is the option to store, within the non-volatile memory, data which defines operator displays on a video display terminal. Other equipment operating parameters may also be stored within the non-volatile memory. FLASH ROM 104 may be periodically reprogrammed to introduce new functions into the device. If operator display information is stored in the FLASH ROM 104, this data may also be periodically reprogrammed. Volatile memory in RAM 102 is used to store information being processed by the CPU 108.

The processing configuration 100 includes a hard disk 118 to store large data objects. Hard disk 118 in the printer embodiment may be used to store data defining documents to be printed while the printer mechanism is busy or until an operator desires to print the document. An example of a printer application which utilizes delayed printing of documents which are stored on a hard drive 118 within the printer includes having the operator initiate printing once the operator is physically located near the printer. This operation allows greater security for the printing of sensitive documents. Such an application may only allow printing of such a document from the operator interface incorporated within the printer itself.

The processing configuration 100 of the example printer embodiment further includes printer interface 114. Printer interface 114 includes hardware necessary to provide electrical connections between the CPU 108 and the physical hardware performing the printing functions. The printer interface 114 is dependent upon the printer hardware that is controlled by the CPU 108 and the processing configuration 100 in general.

The processing configuration 100 of the example embodiment includes a network interface 110. Network interface 110 provides electrical communications between the CPU 108 and external computers or other devices connected to a network shared by the network interface 110. Network interface 110 allows communications of device control information between the CPU 108 and external computers and/or other devices and thereby allows remote control of the device controlled by processing configuration 100 of the example embodiment. The preferred embodiment of a networked printer uses a TCP/IP network for data communications. It is obvious that other communications techniques may be employed for the remote control of the equipment, such as radio communications, dedicated wired communications and other communications links known to practitioners in the relevant arts.

The preferred embodiment utilizes the network interface 110 to provide remote control of the printer controlled by the processing configuration 100 through a HyperText Transfer Protocol (HTTP) server that executes within the CPU 108. This processing is more fully described below.

The processing configuration 100 also includes an operator panel interface hardware 112. The operator panel interface hardware 112 of the example embodiment of the present invention comprises a video display screen that presents displays to the operator. The operator panel interface 112 of alternative embodiments may comprise color or monochrome displays that use a CRT, LCD or other devices to produce a video image. The operator panel interface 112 may also include the capability to display animation or video to the operator. The operator panel interface 112 may optionally include the ability to generate sound as part of the presentation to the operator. The preferred embodiment utilizes sound to generate a “beep” indicator to an operator when an error event or priority status event occurs in the printer. Alternative embodiments my incorporate data files which define encoded voice to annunciate “Out of Toner,” “Out of Paper” and other printer events which require immediate action by the operator.

The operator panel interface 112 of the preferred embodiment includes facilities that allow the operator to input information which is used to control the operation of the printer controlled by the processing configuration 100. The facilities that allow the operator to input information may operate in association with the data or image displayed on the operator panel interface, e.g. the selection of hyperlinks or entry of data into fields of the display. The operator panel interface 112 may include a conventional computer keyboard to allow input of information. Alternative input facilities include the use of a touchscreen as a display which allows the operator to select functions via graphics displayed on the screen. A touchscreen may further be configured to display an alphanumeric keyboard thereby allowing the operator to select letters and/or numbers to enter. Additional input facilities include pointing devices used in graphical computer interfaces such as mice, touchpads, trackballs and joysticks. An operator panel interface 112 may also incorporate handwriting recognition to allow the operator to write instructions or other information for processing by CPU 108.

An operating software structure 200 that executes in CPU 108 in an example embodiment of a network connected printer is illustrated in FIG. 2. The operating system 216 provides the basic support for the other executing software components. Operating system 216 provides inter-process communications paths as well as access to lower level hardware functions within CPU 108.

Executing with operating system support in the preferred embodiment is network stack 202. Network Stack 202 also contains network application modules. The network stack communicates with the web server 204 via an inter-process communications link 220 to allow the web server to communicate over a network communications path to other communications devices that are connected to the network to which the printer is also connected. The network applications of the preferred embodiment also communicate, via inter-process communications, with the Rasteriser(s) 210, which transforms image data into the bit-mapped data required for printing within the preferred embodiment.

Rasterizer(s) 210 receives data defining documents to print and converts the data into a bitmap format for printing by the printer mechanism contained within the printer. Alternative printer embodiments may utilize a plurality of rasterizers 210. The rasteriser of the preferred embodiment receives image data from devices connected to the communications network through the network stack 202 and associated network applications. Rasterizer 210 communicates with the parameter subsystem 212, via inter-process communications path 226 to obtain operating parameters maintained for the printer. The rasteriser 210 produces the bitmap information and delivers it to the mechanism interface code 208 for printing of the document through inter-process communications link 224. The print mechanism interface code 208 drives the printer hardware to produce the hard copy printout. The functioning of the print mechanism interface code 208 is dependent upon the requirements of the printer mechanism used by the printer. The print mechanism interface code 208 retrieves operating parameters which control printing from the parameter subsystem 212 via an interprocess communications link.

Web Server 204 of the preferred embodiment is an HTTP server operating within CPU 108. Web Server 204 generates the data defining displays that are presented to an operator. In the preferred embodiment, the Web Server 204 generates a display data set, which defines a display to be presented to the operator, based upon the HTTP standard. Alternative embodiments may incorporate other network standard protocols or other standard protocols used on computer networks such as Java or XML. The web server 204 may also generate displays that incorporate animation and videos, as is known by practitioners in the relevant arts. The displays defined by the web server 204 may be displayed on any compatible device that communicates electrically with the CPU 108. The electrical communications may be over a Local Area Network (LAN) through network interface 110 of the illustrated embodiment. In the preferred embodiment of the present invention, electronic communications from the web server 204 is also performed through an inter-process communication link 222 with the web browser 206 process operating on the same CPU 108. The web server 204 also receives printer operating parameters that are input by operators either from the operator panel interface 112 attached to the printer of the preferred embodiment or from remote communications terminals connected to the communications network. The web server 204 is configured to communicate and store those operating parameters, via an inter-process communications link, into the parameter subsystem 212 of the preferred embodiment. The parameter subsystem 212 may also store operating parameters for the web server 204, which the web server 204 may then retrieve via an inter-process communications link. The processing performed by Web Server 204 is further defined below.

The Web Browser 206 component of the example embodiment executes within CPU 108 of the preferred embodiment to display operator information that is generated in HTTP format by the Web Server 204 and received via inter-process communications link 222. The web browser 206 of the illustrated embodiment interprets the HTTP formatted operator display dataset that defines the operator interface display and which was generated by the web server 204. Web browser 206 may also display information in other formats generated by the web server 204. The web browser 206 then generates the data necessary to display the operator interface display on the operator panel interface 112. The processing performed by the web browser 206 is further defined below.

The operator panel driver 214 performs low level control and monitoring of operator displays and operator input equipment contained within the printer of the preferred embodiment. The operator panel driver 214 of the preferred embodiment communicates with the web browser 206 software module via an inter-process communications link to receive display information and transmit operator inputs.

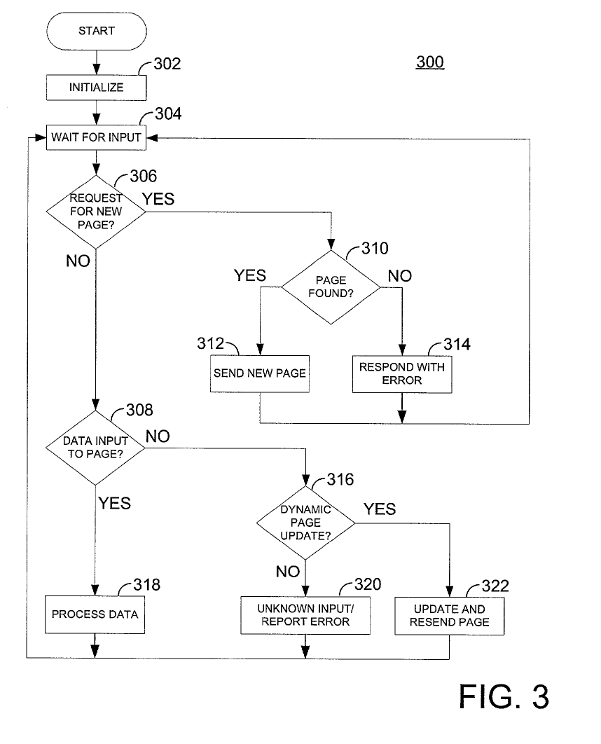

The Web Server processing flow 300, which is performed by the web server 204, is illustrated in FIG. 3. Processing begins, in step 302, wherein the web server initializes local storage, including storage in RAM 102 and hard disk 118, as well as other data used during processing. Processing then advances to step 304 wherein input is received from a web browser. Web server 204 may receive data from the web browser 206 that is integral with the printer of the preferred embodiment or from a web browser operating in a communications device connected to a communications network shared by the printer of the preferred embodiment. The web server 204 may also receive data from other operating elements of the printer of the preferred embodiment, including the parameter subsystem 212.

After receipt of input, the Web Server 204 processing advances to step 306 wherein the input is examined to determine if the data is a request for a new HTTP display page. If the request is for a new web page, processing advances to step 310 to determine if the requested web page is available (i.e. if the page is found). If the requested page has been found, processing advances to step 312 wherein the requested page is sent to the requesting web browser. If the requested page is not found, a display page containing an error message is returned to the requesting web browser in step 314. Processing returns to step 304 after the requested page or the error page is returned to the requesting web browser, wherein processing within the web server suspends until a request for a new page is received.

If step 306 determines that the input is not a request for a new page, processing continues with step 308 to determine if data had been input into a currently displayed web page. If the input contains data input into a currently displayed web page, the processing advances to step 318 wherein the input data is handled. The processing of step 318 is dependent upon the type of data which may be input and the type of processing required for that data. If the processing of step 308 determines that the input is not data input into a currently displayed web page, processing continues with step 316 wherein the input is examined to determine if it is a dynamic page update. A dynamic page update includes processing associated with a displayed status page on a web browser that requires updating of status data displayed on that page. The preferred embodiment may be configured to periodically update a status page displayed on the operator panel interface 112 at either a fixed or variable period. The preferred embodiment may also be configured to update a status display whenever displayed status information changes or when a related event occurs, such as a paper jam or termination of a print job. If a dynamic page update is performed in response to a changed value or status displayed on the page, the changed status or value may be highlighted on the display by, for example, bold text, reverse video, blinking, different colors, animation or graphical emphasis (including arrows pointing at the data, circles around the values, etc.). The web page data that is generated may also include sound to call the operator's attention to the change in status. The preferred embodiment may also be configured to update a status display or any currently displayed page if a priority parameter changes. Embodiments of the present invention may be configured to generate a new display page upon the occurrence of a change of status or error event so as to display the error message on a portion of the screen regardless of display screen being presented to the operator. An example of such an operation would be the display of a printer error message on a configuration display that does not normally contain any error status data.

A priority parameter in the preferred embodiment is a parameter that is configured to trigger a status page update when that parameter changes, and maybe one or more of a paper jam, job start or job end, page stacked, a change in a job's status (such as from waiting to printing), out of toner, out of paper, almost out of toner, almost out of paper, out of staples, waste container full, motor failure, laser failure, fuser temperature high or fuser temperature low. If the input is a dynamic page update, processing advances to step 320 wherein the page is updated and the page is resent to the browser. If the input is not determined to be a dynamic page input, the processing advances to step 322 wherein the input is declared to be unknown and an error page is transmitted to the web browser. The processing after steps 320 and 322 then returns to step 304 wherein processing suspends until further input is received.

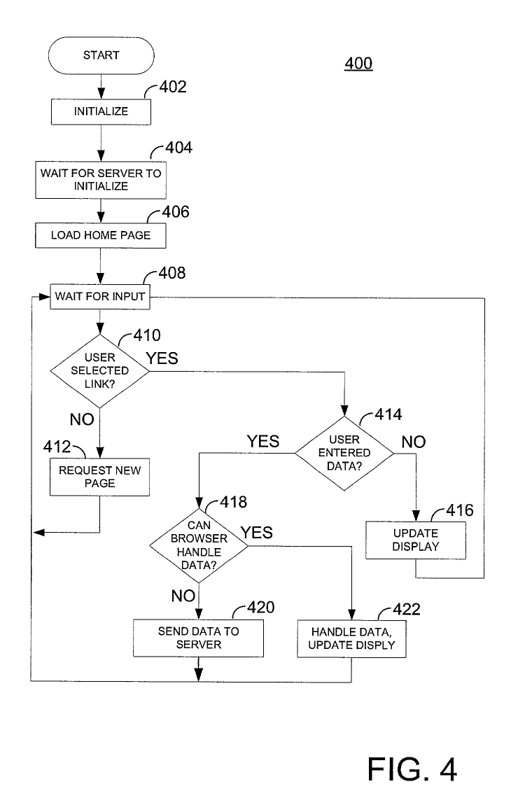

The web browser processing 400, which is performed by the web browser 206 software module is illustrated in FIG. 4. The processing begins, in step 402, with initialization of data structures, including those within RAM 102, and other facilities used by the web browser 206. Processing then advances to step 404 wherein the processing suspends until the attached web server 204 completes its initialization. Once the server initialization has completed, processing advances to step 406 wherein the web browser 206 loads a “home page,” which is a default initial display page, for display to the user. The processing then advances to step 408 wherein processing is suspended until input is received. Input to the web browser 206 maybe received from the web server 204, through an electronic communications or through an inter-process communication facility in the illustrated embodiment, or the input may be from the user via the operator panel interface 112. Input from the user may be received through a keyboard, touchscreen or other input device associated with the operator panel interface 112.

Once input is received processing advances to step 410 to determine if the input is from the user and that input is the selection of a “link.” An example of a link is a “hyperlink,” or icon, which may be selected by the user through the user of a pointing device or similar facility used in conjunction with a graphical display, as in the preferred embodiment. Other embodiments may allow selection of links through use of function keys or other input means used in conjunction with the operator display incorporated into the operator panel interface 112. Selection of a “link” may indicate that a particular command should be executed or a specific action should take place within the device. If the user has selected a link, the processing advances to step 412 where a new display page is requested from the web server 204. If the processing in step 410 determines that the input is not the selection of a link by the user, the processing advances to step 414 wherein the input is examined to determine if the input consists of data entered by the user. The user may enter data to control an aspect of the equipment's operation or cause another action to occur. If the user has entered data, processing advances to step 418 to determine if the data entered may be handled by the browser. A browser may handle data which, for example, causes the display to zoom or otherwise change without requiring additional data to be received from the web server 204. If the browser can handle the data, processing advances to step 422 wherein the browser performs the required processing. If the data cannot be handled by the web browser, the processing advances to step 420 wherein the data is transmitted back to the web server 204 for processing. Processing within the web browser 206 then returns, after performing either of step 420 and 422, to step 408 wherein additional input will be accepted.

If it is determined in step 414 that the user has not entered the input data, the input must have been another web page to display that was received from the web server 204. If the data was received from the web server 204, the processing continues with step 416 wherein the web browser display is updated with the data received from the web server. Processing then returns to step 408 to await further input.

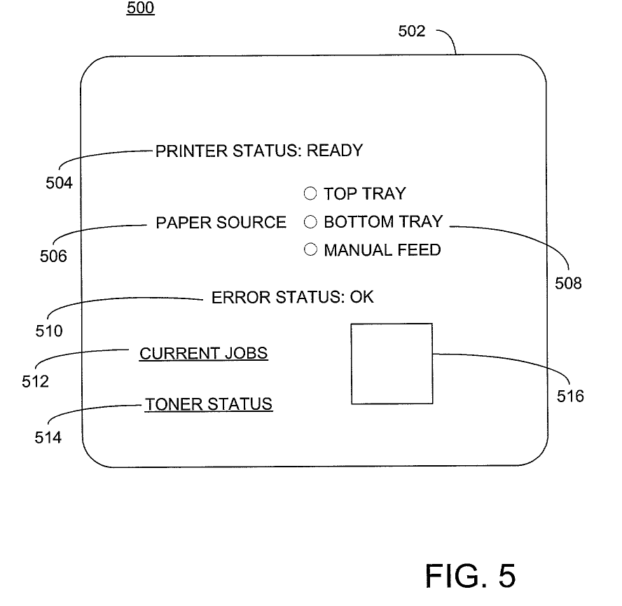

An example of a display 500 as is presented on the operator panel interface 112 is shown in FIG. 5. The operator panel interface physical display of the illustrated embodiment utilizes an LCD display 502 to present the images of the display. The displayed “web page” includes a status line 504 which includes a header of “PRINTER STATUS” and the illustrated display 500 shows the printer's status as “READY.”

Below the status line 504 is a default “PAPER SOURCE” input selector 506. The default “PAPER SOURCE” input selector 506 of the illustrated embodiment allows the operator to select which paper tray will provide paper into the print mechanism. The “PAPER SOURCE” input selector 506 works in conjunction with a three input “radio button” user input selector 508. The illustrated “radio button” input selector 508 allows the operator to select one of three paper sources, a “TOP TRAY,” a “BOTTOM TRAY” or a “MANUAL FEED.” The operation of a “radio button” input selector is known to practitioners in the relevant arts and allows the user to provide an input upon which the printer will respond.

The example display 500 further contains an error status display line 510. The illustrated display shows a status of “OK.” An error state may include a printer paper jam or exhaustion of paper or printer toner. Below the error status display line of the illustrated embodiment are two hyper-links, which allow the user to cause another display to be generated. One hyper-link is a “CURRENT JOBS” link 512. When the “CURRENT JOBS” link 512 is selected, through the facilities of the operator panel interface 112, another page will be generated and displayed on the display 502. The “CURRENT JOBS” link 512 will cause a page displaying the files awaiting to be printed on the printer, i.e. those in the print queue. Below the “CURRENT JOBS” link 512 is a “TONER STATUS” link 514 which causes another display page to be generated, which may be a graphical illustration of the toner cartridge status. The display 500 also includes a image window 516 which is an area where image or video data may be displayed. Video data which may be displayed on the image window 516 includes “how to” guidance for common tasks. Other displays may include hyper-links which allow selection of specific video files, such as help for certain tasks. The video or image displayed on the image window 516 may also be selected by an error status as displayed on the error status line 510. Such a video would instruct a user in correction of the error.

The display 500 that is presented on the operator panel interface 112 of the printer itself on the illustrated embodiment is similar to the display is presented on a remote computer using a web browser. This similarity of display is due to the fact that the same web server 204 generated the display data, and the operator interface 112 incorporates a web browser 206 which operates in a manner that is similar to the web browser of the network connected computer. This increases the ease of use for an operator familiar with one interface and reduces training time for operators who are required to operate the printer from a front panel or remote computer with a web browser.

The present invention incorporates a web server 204 and a web browser 206 within the same device. This allows the operator panel interface 112 to only require generation of the same display information as is provided by the device to remote displays connected via a communications network. This obviates the requirement to develop and maintain two independent sets of operator interface software modules. The prior art has required the development and maintenance of two independent software modules to implement operator interfaces if remote interfaces over a network are desired—a software module to drive the device “front panel” and a separate and independent software module to drive the remote operator control display connected to the device over the communications network. The present invention obviates the requirement to maintain the separate and independent “front panel” operator interface by providing an operator interface on the device that processes and accepts the same displays and processes input in the same way as is performed for remote operator displays connected over a communications network.

It is also obvious that the present invention may be implemented in an automated, stand alone controller that is used to remotely control equipment. An example of a controller used to control Heating, Ventilation and Air Conditioning (HVAC) in a building may use the present invention to provide a “front panel” operator control which is driven by the same HTTP web server that is internal to the controller that can be accessed by other computers over a communications network.

The preferred embodiment of the present invention, as shown in FIG. 1, utilizes a computer controller with a single CPU 108. It is obvious that a computer controller implementing the present invention may utilize a plurality of computer processors, or other dedicated processing hardware, and operate within the scope of the present invention.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of presenting a printer operator interface, the method comprising the steps of:
generating a printer operator display dataset in a processor within a printer, wherein the operator display dataset defines a printer operator interface display and wherein the display dataset conforms to a network protocol;
interpreting the printer operator display dataset within the printer; and
displaying the operator interface display on a display on the printer.

2. The method of claim 1, wherein the network protocol is a HyperText Transfer Protocol.

3. The method of claim 1, wherein the operator display dataset comprises data for one or more of a video, an image, a sound file and an animation display.

4. The method of claim 1, wherein the step of generating the operator display dataset is performed in response to a change in an operating parameter within the printer.

5. The method of claim 4, wherein the operating parameter is categorized as at least one of a priority parameter, a paper jam indicator and an out of paper indicator.

6. The method of claim 1, wherein the step of generating is repetitively performed at a time period.

7. The method of claim 6, wherein the time period is adjusted according to at least one of an operating state of the printer and an error state of the printer.

8. The method of claim 1, further comprising the steps of:
accepting an operator input for the printer through means associated with the operator interface display; and
controlling a function within the printer in response to the operator input.

9. The method of claim 8, wherein the function comprises generating an additional operator interface display.

10. The method of claim 8, wherein the step of accepting utilizes at least one of a pointing device, a keyboard, handwriting recognition, and a touchscreen input.

11. A method of presenting an operator interface for a controller, the method comprising the steps of:
generating an operator display dataset within a computer controller, wherein the operator display dataset defines an operator interface display and wherein the display dataset conforms to a network protocol;
interpreting the operator display dataset within the computer controller; and
displaying the operator interface display.

12. A computer printer, comprising:
an operator display dataset generator for generating a display dataset, wherein the display dataset defines an operator interface display and wherein the display dataset conforms to a network protocol;
a display dataset interpreter, communicatively coupled to the operator display dataset generator, for interpreting the operator display dataset, wherein the display dataset interpreter is contained within the printer; and
an operator interface display, electronically coupled to the display dataset interpreter, for displaying the operator interface display.

13. The system of claim 12, wherein the network protocol is a HyperText Transfer Protocol.

14. The system of claim 12, wherein the operator display dataset comprises data for one or more of a video, an image, a sound file, and an animation display.

15. The system of claim 12, wherein operator display dataset generator operates in response to a change in an operating parameter within the printer.

16. The system of claim 15, wherein the operating parameter is categorized as at least one of a priority parameter, a paper jam indicator and an out of paper indicator.

17. The system of claim 12, wherein the operator display dataset generator operates at a time period.

18. The system of claim 17, wherein the time period is adjusted according to at least one of a state of the printer and an error state of the printer.

19. The system of claim 12, further comprising:
an operator input device for accepting an operator input, wherein the operator input is associated with the operator interface display; and
a device controller, communicatively coupled to the operator input, for controlling a function within the printer in response to the operator input.

20. The system of claim 19, wherein the function comprises the generation of an additional operator interface display.

21. The system of claim 19, wherein the operator input comprises at least one of a pointing device, a keyboard, handwriting recognition means, and a touchscreen input.

22. A computer readable medium including computer instructions for presenting an operator interface for a printer, the computer instructions comprising instructions for:
generating an operator display dataset within a printer, wherein the operator display dataset defines an operator interface display and wherein the display dataset conforms to a network protocol;
interpreting the operator display dataset within the printer; and
displaying the operator interface display.

23. The computer readable medium of claim 22, wherein the network protocol is a HyperText Transfer Protocol.

24. The computer readable medium of claim 22, wherein the operator display dataset comprises data for one or more of a video, a sound file, an image and an animation display.

25. The computer readable medium of claim 22, wherein the instruction for generating the operator display dataset is executed in response to a change in an operating parameter within the printer.

26. The computer readable medium of claim 25, wherein the operating parameter is categorized as at least one of a priority parameter, a paper jam indicator and an out of paper indicator.

27. The computer readable medium of claim 22, wherein the instruction for generating is repetitively executed at a time period.

28. The computer readable medium of claim 27, wherein the time period is adjusted according to at least one of a state of the printer and an error state of the printer.

29. The computer readable medium of claim 22, further including instructions for:
accepting an operator input associated with the operator interface display; and
controlling a function within the printer in response to the operator input.

30. The computer readable medium of claim 29, wherein the function comprises generating an additional operator interface display.

31. The computer readable medium of claim 29, wherein the instruction for accepting accepts input from at least one of a pointing device, a keyboard, handwriting recognition means, and a touchscreen input.
